(19) United States
(12) Patent Application Publication
(10) Pub. No.: US 2026/0338366 A1
(43) Pub. Date: Oct. 29, 2026

(54) INTERCONNECTABLE LIGHT OUTPUT APPARATUS

(71) Applicant: WONTECH CO., LTD., Daejeon (KR)

(72) Inventors: Jong Won KIM, Seongnam (KR); Jung Hyun Kim, Seongnam (KR); Young Seok Seo, Sejong (KR); Han Young Ryu, Daejeon (KR); Ji Yuong Lee, Daejeon (KR); Deok Soo Kim, Daejeon (KR)

(21) Appl. No.: 19/330,874

(22) Filed: Sep. 17, 2025

(30) Foreign Application Priority Data
Apr. 29, 2025 (KR) 10-2025-0056697

(51) Int. Cl. F21V 23/06; F21S 9/02; F21V 23/00

(52) U.S. Cl. CPC F21V 23/06; F21S 9/02; F21V 23/003

(57) ABSTRACT

Proposed is an interconnectable light output apparatus which includes a main body, and an output part electrically connected to the main body. The main body includes a power supply part capable of being charged by wired and wireless methods, a battery part configured to store power from the power supply part and temporarily provide the power to the main body and the output part, a main body connecting part wired to the output part so as to supply power from the power supply part or the battery part, a first control part configured to control operations of the output part and the main body, and a second control part protruding from one side of the main body, coupled to the first control part, and configured to detect and transmit an operation signal to the first control part.

### CROSS REFERENCE TO RELATED APPLICATION

The present application claims priority to Korean Patent Application No. 10-2025-0056697, filed Apr. 29, 2025, the entire contents of which are incorporated herein for all purposes by this reference.

### BACKGROUND OF THE INVENTION

### Field of the Invention

The present disclosure relates generally to a light output apparatus. More particularly, the present disclosure relates to an interconnectable light output apparatus that is positioned near an affected area of a patient to deliver light directly to the affected area and is capable of having multiple parts connected according to the size and location of the affected area.

### Description of the Related Art

Light therapy, a non-invasive treatment method which uses light, is safe and effective, so it is primarily used to facilitate wound healing and skin care. Its application is increasingly expanding to provide mental and physical stability and sleep induction for modern individuals living under stress and suffering from sleep disorders. Recent studies have reported that light therapy may help treat dementia, which significantly impacts elderly welfare in age related disease, thereby drawing considerable attention for its various medical benefits.

Light therapy is a medical technique that utilizes the principle of light promoting biochemical reactions within the human body. Light therapy can be applied not only to skin care, wound treatment, and the treatment of skin diseases such as jaundice, but also as a treatment for mental health conditions such as depression, insomnia, and dementia.

Research and commercialization of light therapy have mainly focused on laser and LED light sources. However, point light source-based devices such as lasers and LEDs present several limitations, including difficulty in providing uniform irradiation over a large area, issues of localized heat generation, and lack of flexibility due to their rigid structure, which prevents close contact with the human body.

In conventional LED mask packs, the LEDs are positioned a significant distance from the skin, which prevents light from reaching the dermal tissue, thereby resulting in minimal effects on skin whitening and wrinkle improvement. Therefore, there is a need for a technology that allows the LEDs to be placed as close to the skin as possible so that the LED light effectively reaches the dermal tissue.

To address the above-described problems, a patch-type light output device which is made of a flexible material and is provided with micro-LEDs has been developed. However, conventional light therapy patches are manufactured as single patches, which may limit their usability according to the size and location of an affected area.

### Document of Related Art

(Patent Document 1) Korean Patent Application Publication No. 10-2022-0115362

### SUMMARY OF THE INVENTION

Accordingly, the present disclosure has been made keeping in mind the above problems occurring in the related art, and an objective of the present disclosure is to provide an interconnectable light output apparatus that is attached to skin in accordance with the location and size of an affected area of a patient so as to deliver light directly to the affected area.

In addition, another objective of the present disclosure is to provide an interconnectable light output apparatus that can be configured to be either attached to an affected area or mounted thereto according to an affected area.

In order to achieve the objectives of the present disclosure, there is provided an interconnectable light output apparatus including: a main body; and an output part electrically connected to the main body,

wherein the main body includes: a power supply part capable of being charged by wired and wireless methods; a battery part configured to store power from the power supply part and temporarily provide the power to the main body and the output part; a main body connecting part wired to the output part so as to supply power from the power supply part or the battery part; a first control part configured to control operations of the output part and the main body; and a second control part protruding from one side of the main body, coupled to the first control part, and configured to detect and transmit an operation signal to the first control part,

wherein the output part includes: a base part which is made of a flexible material and to which components of the output part are coupled; a light output part coupled to a portion of the base part that contacts skin; an electrode part attached to one surface of the base part and configured to conduct power supplied from the main body to the components coupled to the base part; a first connecting part wired to the main body; and second connecting parts configured to connect multiple output parts to each other.

The main body connecting part may be configured to be electrically conductive on an inside thereof, so that power from the main body may be transmitted to the output part.

The apparatus may further include: a wired cable having opposite sides connected to the main body connecting part and the first connecting part, respectively.

The main body may have the main body connecting part, which includes at least one main body connecting parts, and when the main body has two main body connecting parts, the output parts may be coupled to the main body connecting parts, respectively.

The base part may be made of a flexible material, an elastic material, or a rigid material.

Two or more supports may be formed on one surface of the base part that contacts the skin, and the supports may form a gap between the skin and the base part.

Insulating films may be attached to opposite surfaces of the base part, respectively, or the opposite surfaces of the base part may be coated to be insulated so as to prevent electrical conduction to a human body.

The light output part may output light at a wavelength selected from the range of 600nm to 850nm.

The light output part may include at least one light output part attached to the base part.

The first connecting part and the second connecting part may be configured to be electrically conductive on inner surfaces thereof, and receive power from the main body or transmit the power.

The apparatus may further include: a wire configured to connect the second connecting parts to each other when the output parts are interconnected.

When receiving an operation command according to the operation signal applied from the second control part, the first control part of the main body may output power from one of the power supply part and the battery part through the electrode part to check power consumption of the output part.

The first control part may control power so as to provide uniform power to the interconnected output parts by checking power consumption of the interconnected output parts through consumed power and controlling power of the battery part.

According to these features, the interconnectable light output apparatus of the present disclosure can be attached to the affected area of a patient, thereby enabling direct irradiation of the affected area with light.

Furthermore, the apparatus of the present disclosure can be configured by connecting multiple parts to match the size and location of an affected area, thereby enabling simultaneous treatment of a larger area.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a block diagram illustrating a configuration of an interconnectable light output apparatus in accordance with an embodiment of the present disclosure;

FIG. 2 is a schematic diagram illustrating an output part of the interconnectable light output apparatus according to the embodiment of the present disclosure;

FIG. 3 is a schematic diagram of the output unit of an interconnectable light output apparatus according to another embodiment of the present disclosure;

FIG. 4 is a schematic view of the interconnectable light output apparatus installed according to the embodiment of the present disclosure; and

FIGS. 5A and 5B are diagrams schematically illustrating the interconnectable light output apparatus according to the embodiment of the present disclosure.

### DETAILED DESCRIPTION OF THE INVENTION

Hereinafter, an embodiment of the present disclosure will be described in detail with reference to the accompanying drawings so that those skilled in the art to which the present disclosure pertains can easily implement it. However, the present disclosure is not limited to the embodiment described herein and may be implemented in various other forms. In addition, in the drawings, portions unrelated to the present disclosure have been omitted in order to clearly describe the present disclosure, and similar reference numerals are used throughout the specification for similar portions.

Throughout the present specification, when a certain part is described as being “connected (coupled, contacted, or joined)” to another part, it is intended to include not only cases where the two parts are directly connected, but also cases where the two parts are indirectly connected with another member placed therebetween. In addition, when a certain part is described as “including” a specific component, it is to be understood, unless expressly stated otherwise, that the part does not exclude the presence of other components but may further include additional components.

Terms used in the present specification are employed merely to describe a specific embodiment and are not intended to limit the present disclosure. Unless clearly indicated otherwise by the context, singular expressions also include plural expressions. In the present specification, terms such as “comprise” or “have” are intended to specify the presence of a feature, a number, a step, an operation, a component, a part, or combination thereof, but should not be construed as precluding the possibility of the presence or addition of one or more other features, numbers, steps, operations, components, parts, or combinations thereof.

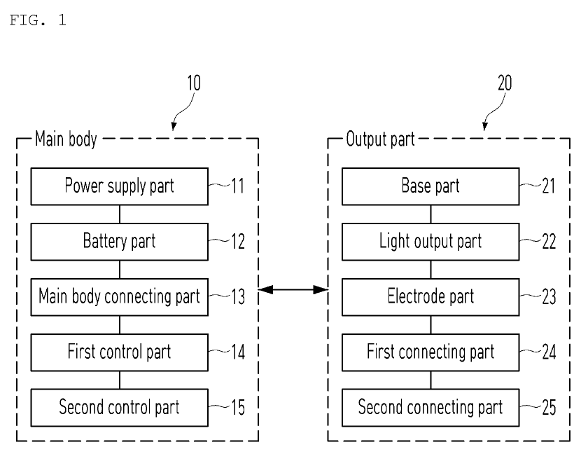

An interconnectable light output apparatus according to an embodiment of the present disclosure will be described with reference to FIGS. 1 to 5.

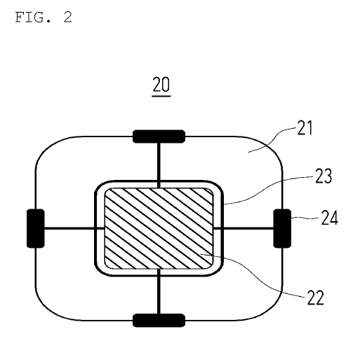

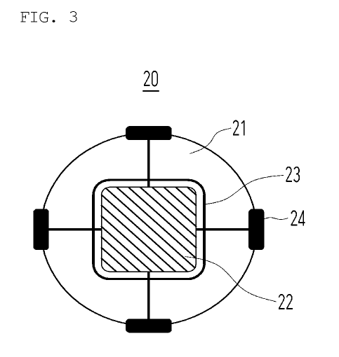

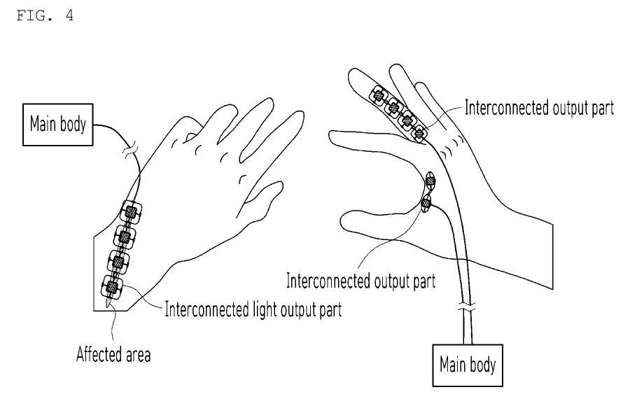

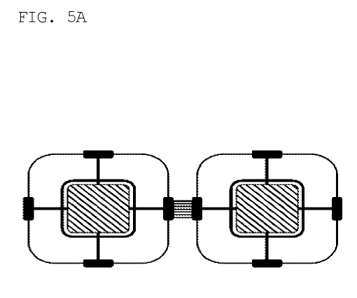

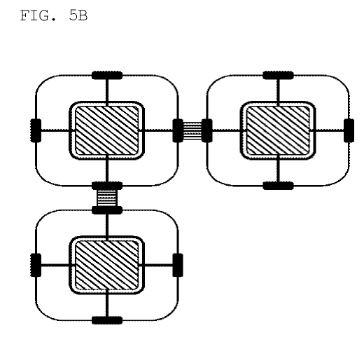

FIG. 1 is a block diagram illustrating a configuration of the interconnectable light output apparatus in accordance with an embodiment of the present disclosure; FIG. 2 is a schematic diagram illustrating an output part of the interconnectable light output apparatus according to the embodiment of the present disclosure; FIG. 3 is a schematic diagram of the output unit of an interconnectable light output apparatus according to another embodiment of the present disclosure; FIG. 4 is a schematic view of the interconnectable light output apparatus installed according to the embodiment of the present disclosure; and FIGS. 5A and 5B are diagrams schematically illustrating the interconnectable light output apparatus according to the embodiment of the present disclosure.

Referring to FIGS. 1 to 5B, the interconnectable light output apparatus includes a main body 10, and an output part 20 electrically connected to the main body 10.

First, the main body 10 includes a power supply part 11 capable of being charged by wired and wireless methods, a battery part 12 configured to store power from the power supply part 11 and temporarily provide the power to the main body 10 and the output part 20, a main body connecting part 13 wired to the output part 20 so as to supply power from the power supply part 11 or the battery part 12, a first control part 14 configured to control operations of the output part 20 and the main body 10, and a second control part 15 protruding from one side of the main body 10, coupled to the first control part 14, and configured to detect and transmit an operation signal to the first control part 14.

Next, the output part 20 includes a base part 21 which is made of a flexible material and to which components of the output part 20 described below are coupled, a light output part 22 coupled to a portion of the base part 21 that touches skin, an electrode part 23 attached to one surface of the base part 21 and configured to conduct power supplied from the main body 10 to the components coupled to the base part 21, a first connecting part 24 wired to the main body 10, and second connecting parts 25 configured to connect multiple output parts 20 to each other.

The main body connecting part 13 is configured to be electrically conductive on an inside thereof, so that power from the main body 10 is transmitted to the output part 20.

In addition, the light output apparatus may further include a wired cable having opposite sides connected to the main body connecting part 13 and the first connecting part 24, respectively.

The main body 10 has the main body connecting part 13, which includes at least one main body connecting parts. For example, when the main body 10 has two main body connecting parts 13, the output parts 20 are coupled to the main body connecting parts 13, respectively.

The main body 10 may further include a display part (not shown) through which operating time or a remaining battery level are checked.

The base part 21 is preferably made of a flexible material, but may be made of an elastic or rigid material. In addition, two or more supports may be formed on one surface of the base part 21 that contacts the skin, and the supports may form a gap between the skin and the base part 21.

Insulating films are attached to opposite surfaces of the base part 21, respectively, or the opposite surfaces of the base part 21 are coated to be insulated so as to prevent electrical conduction to a human body.

The base part 21 is preferably formed in a circular or quadrilateral shape, but is not limited thereto.

The light output part 22 outputs light at a wavelength selected from the range of 600 nm to 850 nm.

In addition, the light output part 22 includes at least one light output part attached to the base part 21, but is not limited thereto.

The electrode part 23 is attached to the base part and transmits power supplied from the main body 10.

The first connecting part 24 and the second connecting part 25 are configured to be electrically conductive on inner surfaces thereof, and receive power from the main body 10 or transmit the power.

In addition, the light output apparatus includes a wire configured to connect the second connecting parts to each other when the output parts 20 are interconnected.

Referring to FIG. 4, the output parts may be configured in an interconnected form and attached to the affected area of a patient.

In addition, a plurality of interconnected output parts may be configured, each of which may be coupled to the main body connecting part of the main body to receive power.

When receiving an operation command according to the operation signal applied from the second control part 15, the first control part 14 of the main body 10 outputs power from one of the power supply part 11 and the battery part 12 through the electrode part to check power consumption of the output part.

The first control part 14 controls power so as to provide uniform power to the interconnected output parts by checking power consumption of the interconnected output parts through consumed power and controlling power of the battery part.

Although the embodiments of the present disclosure have been described in detail above, the scope of the present disclosure is not limited thereto, and various modifications and improvements by those skilled in the art using the basic concepts of the present disclosure as defined in the following claims also fall within the scope of the present disclosure.

What is claimed is:

1. An interconnectable light output apparatus comprising:
a main body; and
an output part electrically connected to the main body,
wherein the main body includes:
a power supply part capable of being charged by wired and wireless methods;
a battery part configured to store power from the power supply part and temporarily provide the power to the main body and the output part;
a main body connecting part wired to the output part so as to supply power from the power supply part or the battery part;
a first control part configured to control operations of the output part and the main body; and
a second control part protruding from one side of the main body, coupled to the first control part, and configured to detect and transmit an operation signal to the first control part,
wherein the output part includes:
a base part which is made of a flexible material and to which components of the output part are coupled;
a light output part coupled to a portion of the base part that contacts skin;
an electrode part attached to one surface of the base part and configured to conduct power supplied from the main body to the components coupled to the base part;
a first connecting part wired to the main body; and
second connecting parts configured to connect multiple output parts to each other.

2. The apparatus of claim 1, wherein the main body connecting part is configured to be electrically conductive on an inside thereof, so that power from the main body is transmitted to the output part.

3. The apparatus of claim 1, further comprising:
a wired cable having opposite sides connected to the main body connecting part and the first connecting part, respectively.

4. The apparatus of claim 1, wherein the main body has the main body connecting part, which includes at least one main body connecting parts, and when the main body has two main body connecting parts, the output parts are coupled to the main body connecting parts, respectively.

5. The apparatus of claim 1, wherein the base part is made of a flexible material, an elastic material, or a rigid material.

6. The apparatus of claim 1, wherein two or more supports are formed on one surface of the base part that contacts the skin, and the supports form a gap between the skin and the base part.

7. The apparatus of claim 1, wherein insulating films are attached to opposite surfaces of the base part, respectively, or the opposite surfaces of the base part are coated to be insulated so as to prevent electrical conduction to a human body.

8. The apparatus of claim 1, wherein the light output part outputs light at a wavelength selected from the range of 600nm to 850nm.

9. The apparatus of claim 1, wherein the light output part includes at least one light output part attached to the base part.

10. The apparatus of claim 1, wherein the first connecting part and the second connecting part are configured to be electrically conductive on inner surfaces thereof, and receive power from the main body or transmit the power.

11. The apparatus of claim 1, further comprising:
a wire configured to connect the second connecting parts to each other when the output parts are interconnected.

12. The apparatus of claim 1, wherein when receiving an operation command according to the operation signal applied from the second control part, the first control part of the main body outputs power from one of the power supply part and the battery part through the electrode part to check power consumption of the output part.

13. The apparatus of claim 1, wherein the first control part controls power so as to provide uniform power to the interconnected output parts by checking power consumption of the interconnected output parts through consumed power and controlling power of the battery part.
